(19) United States
(12) Patent Application Publication
(10) Pub. No.: US 2011/0252110 A1
(43) Pub. Date: Oct. 13, 2011

(54) METHOD AND SYSTEM FOR FILTERING AND DISPLAYING INFORMATION FROM DIFFERENT SOURCES

(75) Inventors: Yi-Hsi Wu, Taipei City (TW); Chien-Yuan Chen, Taipei City (TW); Chun-Cheng Chen, Taipei City (TW); Chia-Chen Wang, Taipei City (TW)

(73) Assignee: COMPAL ELECTRONICS, INC., Taipei City (TW)

(21) Appl. No.: 12/790,993

(22) Filed: Jun. 1, 2010

(30) Foreign Application Priority Data
Apr. 12, 2010 (TW) 99111263

(51) Int. Cl. G06F 15/16; G06F 9/46; G06F 17/30

(52) U.S. Cl. 709/217; 707/754; 709/227; 718/100; 707/E17.059

(57) ABSTRACT

A method and a system for filtering and displaying information from different sources are provided for a terminal device. In the method, a filtering program resident in the terminal device is provided to set at least one information type and one relevant interested condition, and the terminal device is connected to different information sources. After the terminal device connects to at least one information source corresponding to the information type, a specific information is extracted from at least one information updated by the information source according to the relevant interested condition, and the specific information is displayed on a desktop of the terminal device so as to assist a user in obtaining the important information more effectively.

### CROSS-REFERENCE TO RELATED APPLICATION

This application claims the priority benefit of Taiwan application serial no. 99111263, filed on Apr. 12, 2010. The entirety of the above-mentioned patent application is hereby incorporated by reference herein and made a part of specification.

### BACKGROUND OF THE INVENTION

1. Field of the Invention

The invention relates generally to a method for displaying information, and more particularly, to a method and a system for displaying filtered information.

2. Description of Related Art

In this age of information explosion with the rapidly developed Internet, besides obtaining new information from books, newspapers, periodicals, or television media, modern people may also retrieve needed information from all sorts of websites or emails. Along with an increasing diversity of information transmission mediums, the methods for retrieving information have also become quite flexible.

However, in order to display different types of information or information originating from different sources, a multitude of distinct application software programs are required. Therefore, when a user is interested in information from a specific source or of a specific type, the user is required to select and execute a suitable application software program to view an information content. In other words, the user must actively retrieve an updated information. From the user's point of view, when a quantity of interested information which requires tracking becomes enormous and diversified, then a large amount of time is required to execute each type of corresponding application software programs. Hence, an information retrieval efficiency cannot be effectively enhanced.

Moreover, while the user is retrieving the updated information by using the suitable application software program, the user may be faced with a selection difficulty due to the bulk of the new information. As a result, the information content which the user is actually interested may be lost.

### SUMMARY OF THE INVENTION

An aspect of the invention provides a method for filtering and displaying information from different sources, in which after a user-configured condition is obtained, the method automatically retrieves an information of a specific type according to the condition, and prompts the user by using a desktop of a device.

An aspect of the invention provides a system for filtering and displaying information from different sources, capable of assisting the user to rapidly obtain relevant information effectively.

An aspect of the invention provides a method for filtering and displaying information from different sources adapted for a terminal device. The method includes providing a filtering program resident in the terminal device, setting at least one information type and one relevant interested condition through the filtering program, and connecting the terminal device to different information sources. After the terminal device connects to at least one information source corresponding to the information type, a specific information is extracted from information updated by the information source according to the relevant interested condition, and the specific information is displayed on the desktop of the terminal device.

According to an embodiment of the invention, the information source includes a Location Based Service (LBS) provider, and the corresponding information type provided is LBS. The method for filtering and displaying information further includes connecting the terminal device to the LBS provider through a communication module in the terminal device, and mutually communicating with the LBS provider.

According to an embodiment of the invention, the communication module includes one of a Global Positioning System (GPS) module and a Bluetooth module.

According to an embodiment of the invention, the information source includes a web mail server, and the corresponding information type provided is email. The method for filtering and displaying information further includes connecting the terminal device to the web mail server through a network, and mutually communicating with the web mail server.

According to an embodiment of the invention, the information source includes a Really Simple Syndication (RSS) service provider, and the corresponding information type provided is RSS. The method for filtering and displaying information further includes connecting the terminal device to the RSS service provider through a network, and mutually communicating with the RSS service provider.

According to an embodiment of the invention, the information source includes a local application program installed in the terminal device, and the corresponding information type provided is a task of the local application program.

According to an embodiment of the invention, the step of extracting the specific information from the information updated by the information source according to the relevant interested condition includes, transmitting the updated information through the information source to the terminal device, and extracting the specific information through the terminal device from the updated information according to the relevant interested condition.

According to an embodiment of the invention, the step of extracting the specific information from the information updated by the information source according to the relevant interested condition includes, sending a request message through the terminal device to the information source, in which the request message includes the relevant interested condition. Moreover, the specific information is extracted through the information source from updated information according to the relevant interested condition, and then the specific information is transmitted to the terminal device.

According to an embodiment of the invention, an information matching the information type follows the Hypertext Markup Language 5 (HTML 5) format.

From another perspective, an aspect of the invention provides a system for filtering and displaying information from different sources, the system including a terminal device and at least one information source. The terminal device includes a filtering program and a display. The filtering program is resident in the terminal device, adapted for setting at least one information type and one relevant interested condition. The display is adapted for displaying a desktop of the terminal device. Each information source is adapted for providing an information according to the information type. After the terminal device connects to the information source, a specific information is extracted from information updated by the information source according to the relevant interested condition, and the specific information is displayed on the desktop of the terminal device.

According to an embodiment of the invention, the information source includes a LBS provider, and the corresponding information type provided is LBS. The terminal device further includes a communication module, for connecting the terminal device to the LBS provider, such that the terminal device and the LBS provider mutually communicate.

According to an embodiment of the invention, the communication module includes one of a GPS module and a Bluetooth module.

According to an embodiment of the invention, the information source includes a web mail server, and the corresponding information type provided is email. The terminal device connects to the web mail server through a network, and the terminal device and the web mail server mutually communicate.

According to an embodiment of the invention, the information source includes a RSS service provider, and the corresponding information type provided is RSS. The terminal device connects to the RSS service provider through a network, and the terminal device and the RSS service provider mutually communicate.

According to an embodiment of the invention, the information source includes a local application program installed in the terminal device, and the corresponding information type provided is a task of the local application program.

According to an embodiment of the invention, the information source transmits the updated information to the terminal device, and the terminal device extracts the specific information from the updated information according to the relevant interested condition.

According to an embodiment of the invention, the terminal device sends a request message to the information source, in which the request message includes the relevant interested condition. The information source extracts the specific information from all the updated information according to the relevant interested condition, and transmits the specific information to the terminal device.

According to an embodiment of the invention, an information matching the information type follows the HTML 5 format.

In summary, an embodiment of the invention employs the filtering program resident in the terminal device to set the information type and the relevant interested condition, so that when the corresponding information source has updated information, the relevant interested condition is automatically used for filtering the updated information, and thereby displaying information truly relevant to the user on the desktop of the terminal device. Accordingly, the user is assisted in rapidly finding a needed information effectively.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a system for filtering and displaying information from different sources in accordance with an embodiment of the invention.

FIG. 2 is a flowchart illustrating a method for filtering and displaying information from different sources in accordance with an embodiment of the invention.

FIG. 3 is a block diagram illustrating a system for filtering and displaying information from different sources in accordance with another embodiment of the invention.

### DESCRIPTION OF THE EMBODIMENTS

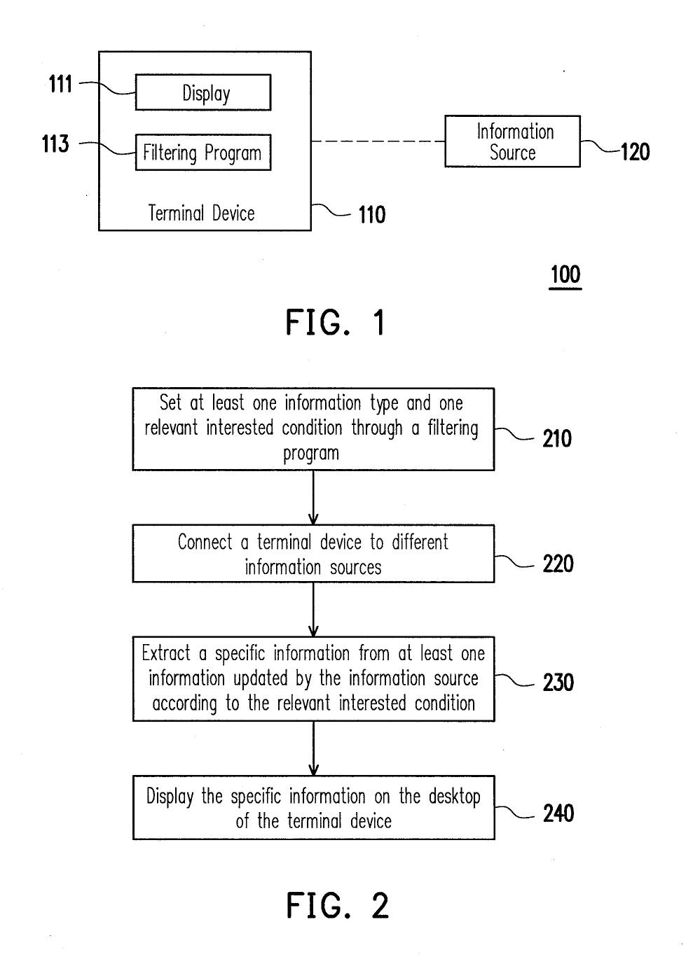

FIG. 1 is a block diagram illustrating a system for filtering and displaying information from different sources in accordance with an embodiment of the invention. Referring to FIG. 1, a system for filtering and displaying information 100 includes a terminal device 110 and an information source 120.

The terminal device 110 is, for example but not limited to, a desktop computer, a notebook computer, a mobile telephone, or a personal data processing device. In the present embodiment of the invention, the terminal device 110 includes a display 111 and a filtering program 113. The display 111 may be a liquid crystal screen or a touch screen for displaying a desktop of the terminal device 110. After the filtering program 113 is configured in the terminal device 110, the filtering program 113 becomes a resident program in the terminal device 110. The filtering program 113 is used for setting at least one information type and one relevant interested condition according to an user input.

An information source 120 connected to the terminal device 110 is used for providing an information according to the information type. For example, when the information type is a Location Based Service (LBS), the information source 120 is for instance a LBS provider set up by a telecommunication company. When the information type is email, the information source 120 is for instance a web mail server. When the information type is a Really Simple Syndication (RSS), the information source 120 is a RSS service provider. It should be noted that, although the information source 120 depicted in FIG. 1 is drawn outside of the terminal device 110, in another embodiment of the invention, the information source 120 may also be a local application program installed in the terminal device 110 capable of providing an information type that is a task of the local application program. For example, the local application program may be an Outlook application program developed by Microsoft Corp., and a task may be a calendar software of the Outlook application program.

In order to further describe the system for filtering and displaying information 100 in detail, another embodiment will be illustrated as follows to describe the invention. FIG. 2 is a flowchart illustrating a method for filtering and displaying information from different sources in accordance with an embodiment of the invention. Please refer to FIGS. 1 and 2 concurrently for the description hereafter.

After providing the filtering program 113 resident in the terminal device 110, at least one information type and one relevant interested condition are set through the filtering program 113 in a Step 210. It should be mentioned that the relevant interested condition for different information types may include dissimilar content. For example, when the information type is LBS, the relevant interested condition may be a street name, a landmark (e.g., a store name), or a complete address, etc. When the information type is email, the relevant interested condition is for instance, a sender, a receiver, and a mail subject, etc. When the information type is RSS, the relevant interested condition includes a web address or any user-configured key terms. When the information type is a task of the local application program, the relevant interested condition may be an event name, etc. In the present embodiment, according to the information type and the relevant interested condition previously set, the filtering program 113 determines whether the information type and the relevant interested condition to be set will be repeated. If the user has employed the filtering program 113 to define a same information type and relevant interested condition, then the filtering program 113 does not set the same type of content again.

Thereafter, as illustrated in a Step 220, the terminal device 110 is connected to different information sources. For example, the terminal device 110 is connected to the corresponding information source 120 according to the information type which is set through the filtering program 113. More specifically, if the information type is LBS, the terminal device 110 may be connected to the LBS provider through a communication module (not drawn) in the terminal device 110, thereby achieving mutual communication with the LBS provider. The communication module is, for example but not limited to, a Global Positioning System (GPS) module or a Bluetooth module, etc. When the information type is email or RSS, the terminal device 110 may be connected to the web mail server or the RSS service provider through a network, and thereby achieve mutual communication.

After the terminal device 110 connects to the information source 120 corresponding to the information type, in a Step 230, when the information source 120 updates at least one information, a specific information is extracted from among all the updated information according to the relevant interested condition. Since the relevant interested condition is user-configured, the specific information according to the relevant interested condition can be viewed as an information the user finds relevant and important.

In an embodiment of the invention, since after a period of time, the information source 120 automatically delivers new information generated in the period of time to the terminal device 110, therefore, after the information source 120 transmits the above-described updated information to the terminal device 110, the terminal device 110 extracts the specific information from all the updated information according to the relevant interested condition. In other words, the updated information is downloaded to the terminal device 110 for comparison and filtering in the local terminal.

In another embodiment of the invention, since the terminal device 110 may also automatically request the information source 120 to provide updated information, hence after the terminal device 110 sends a request message including the relevant interested condition to the information source 120, the information source 120 extracts the specific information from the updated information according to the relevant interested condition, and sends back only the filtered specific information to the terminal device 110. More specifically, herein the information comparison and filtering process is performed in cloud, and only the specific information is returned to the terminal device 110.

Finally, as illustrated in a Step 240, the filtered specific information is displayed on the desktop of the terminal device 110. In the present embodiment, as long as the terminal device 110 is connected to the information source 120 corresponding to the information type, then a new information having this information type and in accordance with the relevant interested condition is automatically and continually displayed on the desktop of the terminal device 110. Thus for the user, relevant information can be directly viewed with the display 111 of the terminal device 110.

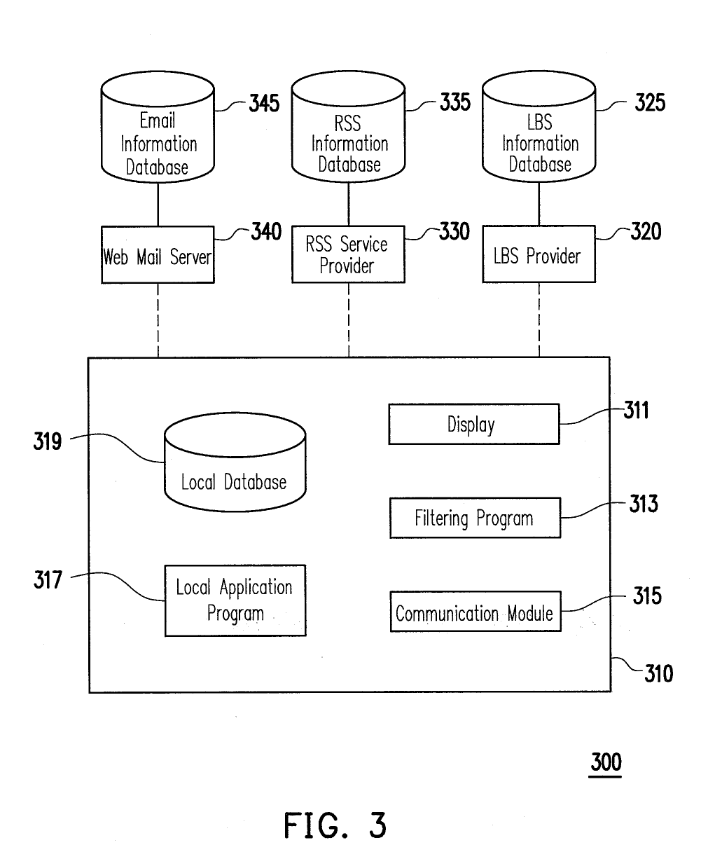

FIG. 3 is a block diagram illustrating a system for filtering and displaying information from different sources in accordance with another embodiment of the invention. In a system for filtering and displaying information 300 depicted in FIG. 3, the information types a user of a terminal device 310 selects through the filtering program 313 are LBS, email, RSS, and a task of a local application program. Moreover, one relevant interested condition for the information types is set through the filtering program 313. In the present embodiment, an information matching the four information types follows the Hypertext Markup Language 5 (HTML 5) format.

Once the terminal device 310 connects to a LBS provider 320 through a communication module 315 therein, whenever the LBS provider 320 obtains updated LBS information from a LBS information database 325, a LBS information according to the relevant interested condition is extracted.

After the terminal device 310 connects to a RSS service provider 330 through a network, whenever the RSS service provider 330 obtains updated RSS information from a RSS information database 335, a RSS information according to the relevant interested condition is extracted.

Likewise, after the terminal device 310 connects to a web mail server 340 through a network, whenever the web mail server 340 obtains updated email information from an email information database 345, an email information according to the relevant interested condition is extracted.

Furthermore, when a local application program 317 obtains updated task information from a local database 319, a task information according to the relevant interested condition is extracted.

When the information matches the information type selected by the user, and the information coincides with the user-configured interested condition, the content of the information is directly displayed by the display 311 on the desktop of the terminal device 310. In other words, the system for filtering and displaying information 300 respectively filters the newest information generated by each information source, and displays only the information matching the user-configured interested condition on the desktop. Therefore, even when the user selects many information types, only the information deemed relevant and important by the user is continually followed and displayed.

As described above, in the method and the system for filtering and displaying information from different sources according to embodiments of the invention, among a plurality of information sources, the information sources providing specific information types in accordance to the user's need are followed. Once the aforesaid information sources update information, filtering is performed according to the relevant interested condition previously set by the user, and the filtered information is directly displayed on the desktop of the terminal device. Therefore, not only can the display of dissimilar information types be integrated, at the same time, the information that the user is concerned with is automatically extracted according to the user's needs, thereby helping the user to effectively obtain needed information.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method for filtering and displaying information from different sources adapted for a terminal device, the method comprising:
providing a filtering program resident in the terminal device;
setting at least one information type and one relevant interested condition through the filtering program;
connecting the terminal device to different information sources;
after the terminal device connects to at least one information source corresponding to the information type, extracting a specific information from at least one information updated by the information source according to the relevant interested condition; and
displaying the specific information on a desktop of the terminal device.

2. The method for filtering and displaying information as claimed in claim 1, wherein the information source comprises a Location Based Service (LBS) provider, and the corresponding information type provided is LBS, the method further comprising:
connecting the terminal device to the LBS provider through a communication module in the terminal device, and mutually communicating with the LBS provider.

3. The method for filtering and displaying information as claimed in claim 2, wherein the communication module comprises one of a Global Positioning System (GPS) module and a Bluetooth module.

4. The method for filtering and displaying information as claimed in claim 1, wherein the information source comprises a web mail server, and the corresponding information type provided is email, the method further comprising:
connecting the terminal device to the web mail server through a network, and mutually communicating with the web mail server.

5. The method for filtering and displaying information as claimed in claim 1, wherein the information source comprises a Really Simple Syndication (RSS) service provider, and the corresponding information type provided is RSS, the method further comprising:
connecting the terminal device to the RSS service provider through a network, and mutually communicating with the RSS service provider.

6. The method for filtering and displaying information as claimed in claim 1, wherein the information source comprises a local application program installed in the terminal device, and the corresponding information type provided is a task of the local application program.

7. The method for filtering and displaying information as claimed in claim 1, wherein the step of extracting the specific information from the at least one information updated by the information source according to the relevant interested condition comprises:
transmitting the at least one information to the terminal device by the information source; and
extracting the specific information through the terminal device from the at least one information according to the relevant interested condition.

8. The method for filtering and displaying information as claimed in claim 1, wherein the step of extracting the specific information from the at least one information updated by the information source according to the relevant interested condition comprises:
sending a request message through the terminal device to the information source, wherein the request message comprises the relevant interested condition; and
extracting the specific information through the information source from the at least one information according to the relevant interested condition, and transmitting the specific information to the terminal device.

9. The method for filtering and displaying information as claimed in claim 1, wherein an information matching the information type follows a Hypertext Markup Language 5 (HTML 5) format.

10. A system for filtering and displaying information from different sources, comprising:
a terminal device comprising:
a filtering program resident in the terminal device, for setting at least one information type and one relevant interested condition; and
a display for displaying a desktop of the terminal device; and
at least one information source providing an information according to the information type,
wherein after the terminal device connects to the information source, a specific information is extracted from at least one information updated by the information source according to the relevant interested condition, and the specific information is displayed on the desktop.

11. The system for filtering and displaying information as claimed in claim 10, wherein the information source comprises a LBS provider, and the corresponding information type provided is LBS, the terminal device further comprising:
a communication module adapted to connect the terminal device to the LBS provider, such that the terminal device and the LBS provider mutually communicate.

12. The system for filtering and displaying information as claimed in claim 11, wherein the communication module comprises one of a GPS module and a Bluetooth module.

13. The system for filtering and displaying information as claimed in claim 10, wherein the information source comprises a web mail server, the corresponding information type provided is email, the terminal device connects to the web mail server through a network, and the terminal device and the web mail server mutually communicate.

14. The system for filtering and displaying information as claimed in claim 10, wherein the information source comprises a RSS service provider, the corresponding information type provided is RSS, the terminal device connects to the RSS service provider through a network, and the terminal device and the RSS service provider mutually communicate.

15. The system for filtering and displaying information as claimed in claim 10, wherein the information source comprises a local application program installed in the terminal device, and the corresponding information type provided is a task of the local application program.

16. The system for filtering and displaying information as claimed in claim 10, wherein the information source transmits the at least one information which is updated to the terminal device, and the terminal device extracts the specific information from the at least one information according to the relevant interested condition.

17. The system for filtering and displaying information as claimed in claim 10, wherein the information source transmits a request message to the terminal device, wherein the request message comprises the relevant interested condition, and the information source extracts the specific information from the at least one information which is updated according to the relevant interested condition, and transmits the specific information to the terminal device.

18. The system for filtering and displaying information as claimed in claim 10, wherein an information matching the information type follows the HTML 5 format.
